(19) United States
(12) Patent Application Publication
(10) Pub. No.: US 2007/0036154 A1
(43) Pub. Date: Feb. 15, 2007

(54) Mobile phone charging base and wireless server

(76) Inventor: Steve B. Lipman, Sherman Oaks, CA (US)

Correspondence Address: ANDREWS KURTH LLP, 1350 I STREET, N.W., SUITE 1100, WASHINGTON, DC, 20005, US

(21) Appl. No.: 11/182,856

(22) Filed: Jul. 18, 2005

(51) Int. Cl. H04L 12/66; H04M 1/00

(52) U.S. Cl. 370/356; 455/575.1

(57) ABSTRACT

A mobile phone charging base includes a mobile phone charging device. The mobile phone is configured for Voice over Internet Protocol communications. The base also includes a wireless communications module with an Internet Protocol (IP) access connection and a Voice over Internet Protocol connection.

### TECHNICAL FIELD

The technical field is wireless communications devices, and more specifically components used to charge the wireless communications devices and to provide various services to the wireless communications devices over specific radio frequency spectra.

### BACKGROUND

Wireless communication devices are, by their nature, portable. As such, the devices use batteries for much of their operation, and the batteries need to be recharged periodically. Battery charging is normally accomplished by inserting the device into an associated charging base or otherwise connecting the device to a source of AC power that is rectified and reduced in voltage to match the battery's voltage, typically about five (5) volts DC. FIG. 1 illustrates a typical charging component in current use.

As can be seen from FIG. 1, charging component 10 includes a molded base 11 into which mobile phone 12 is inserted. Electrical contacts (not shown) in the base 11 mate with corresponding contacts connected to the mobile phone's battery to provide electrical power to charge the battery.

Although not specifically illustrated in FIG. 1, the charging component 10, like other existing mobile phone charging devices, provides only one function, namely charging the mobile phone's battery.

### SUMMARY

What is disclosed is a mobile phone charging base, comprising a mobile phone charging device, and a wireless communications module. The wireless communications module comprises an Internet Protocol (IP) access connection and a Voice over Internet Protocol connection.

Also disclosed is a combinational mobile phone charging device and wireless communications hub comprising a mobile phone charging device; an access point router, comprising a DHCP server, and an omni-directional send/receive antenna; a Web server; and a wireless client module.

Further, what is disclosed is a wireless communication hub for use with a mobile phone comprising means for docking the mobile phone; means for charging a battery of the mobile phone; and means for establishing wireless Internet communications.

Still further, what is disclosed is a method for providing wireless Internet communications comprising the steps of providing a Voice over Internet Protocol (VoIP) mobile phone; providing means to charge a battery of the VoIP mobile phone; and providing a wireless communications hub, the wireless communications hub comprising an access point server, a Web server, and a wireless client module, wherein the charging means and the wireless communications hub are provided in a single housing.

### DESCRIPTION OF THE DRAWINGS

The detailed description will refer to the following drawings in which like numerals refer to like items, and in which:

FIG. 1 illustrates a prior art mobile phone charging base;

FIG. 2 is a front isometric view of a combined charging device and wireless server;

FIG. 3 is a bottom view of the combined charging device and wireless server;

FIG. 4 is a block diagram of the components of the combined charging device and wireless server; and

FIG. 5 is a conceptual view of the combined charging device and wireless server in an operating environment.

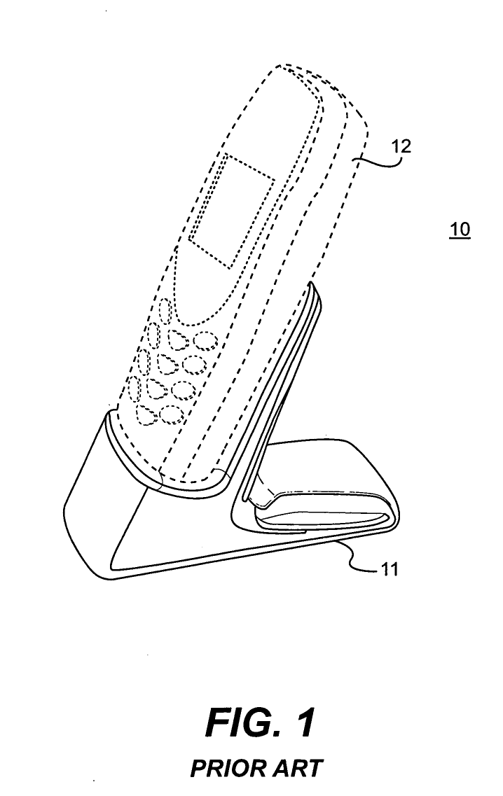

### DETAILED DESCRIPTION

A combined wireless device charging base and wireless server (hereafter, wireless base) provides enhanced mobility and functionality when using mobile telephones and assorted wireless devices. The wireless base includes a mobile telephone charging device that is used to charge a battery of the mobile telephone. The mobile telephone may be a voice over Internet Protocol (VoIP) mobile telephone, which the wireless base is configured to support. The wireless base also includes a wireless communications module. With the wireless communications module, the wireless base functions as a wireless access point, and provides a wireless local network for various wireless devices such as laptop computers and personal data assistants.

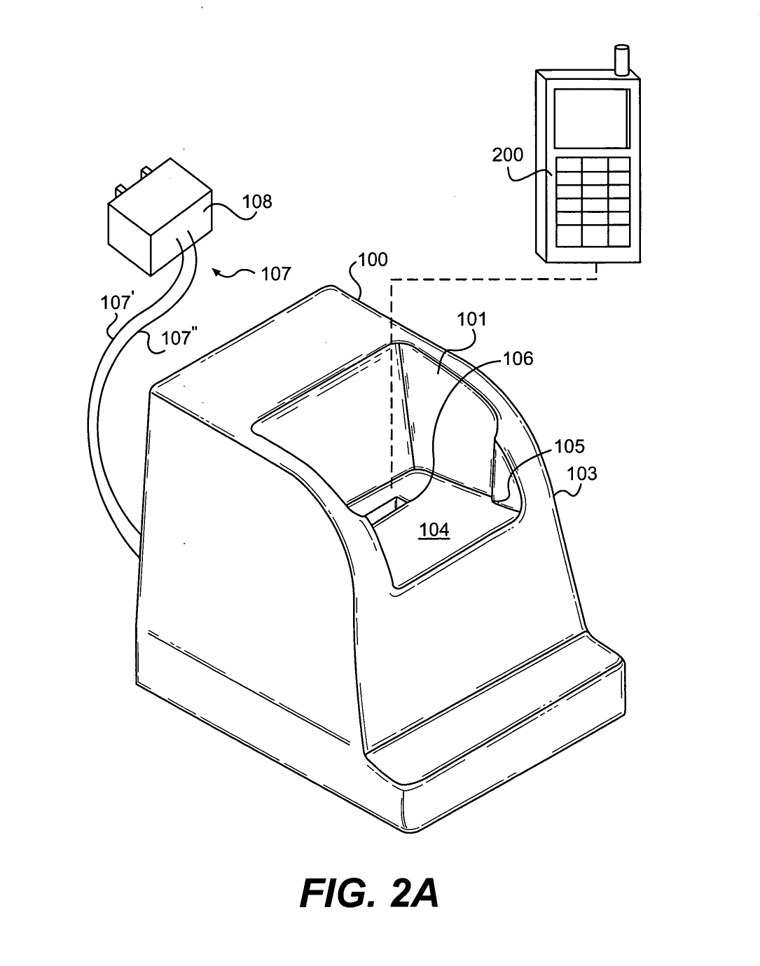

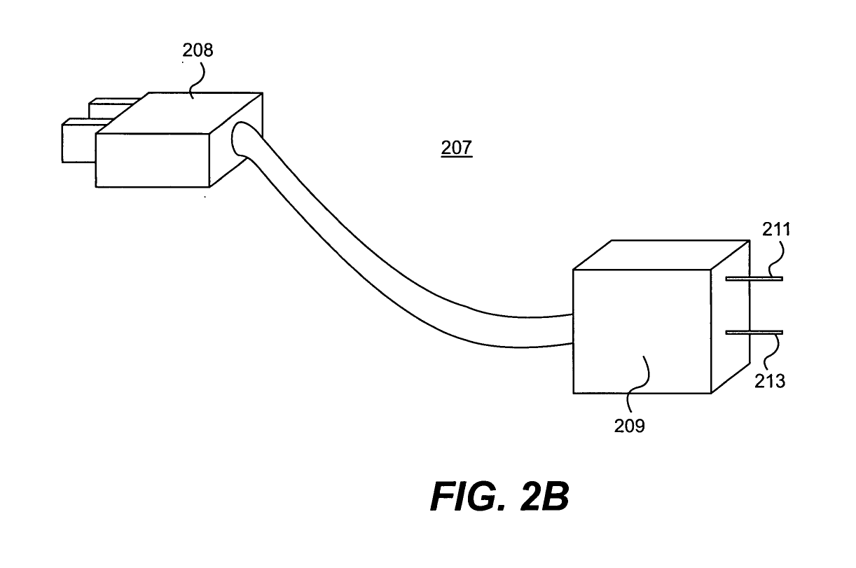

FIG. 2A illustrates an embodiment of a combined mobile phone charging device and wireless server, or base, 100. The base 100 includes a docking station 101 for recharging a mobile phone battery of mobile phone 200. The battery is internal to the mobile phone 200 and is not visible in FIG. 2A. The base 100 also includes a molded shell body 103, which is generally hollow and is formed to receive various electronic components. The docking station 101 has a reception area 104 that mates with a portion of the mobile phone 200 such that the mobile phone 200 is held securely in place during battery charging operations. To enhance the security of the mobile phone 200, the reception area 104 may incorporate means 105 for locking the mobile phone 200 in place. Such means may include detent mechanisms that mate with corresponding portions of the mobile phone 200, or flexible tabs that mate with corresponding depressions on the mobile phone 200. Other locking mechanisms may also be used with the docking station 101 to securely hold the mobile phone 200. The docking station 101 further includes electrical contacts 106 that mate with corresponding contacts (not shown) on the mobile phone 200 to provide DC current to charge the battery.

Attached to the docking station 101 is combinational power cord 107. In an embodiment, the combinational power cord 107 includes power pack 108, first element 107′ and second element 107″. The combinational power cord 107 receives standard power (typically 120 volts, 60 Hz) and the power pack 108 converts the input power to a low voltage DC output (approximately 5 volts), which is supplied to the docking station 101 through the first element 107′ to charge the mobile phone battery.

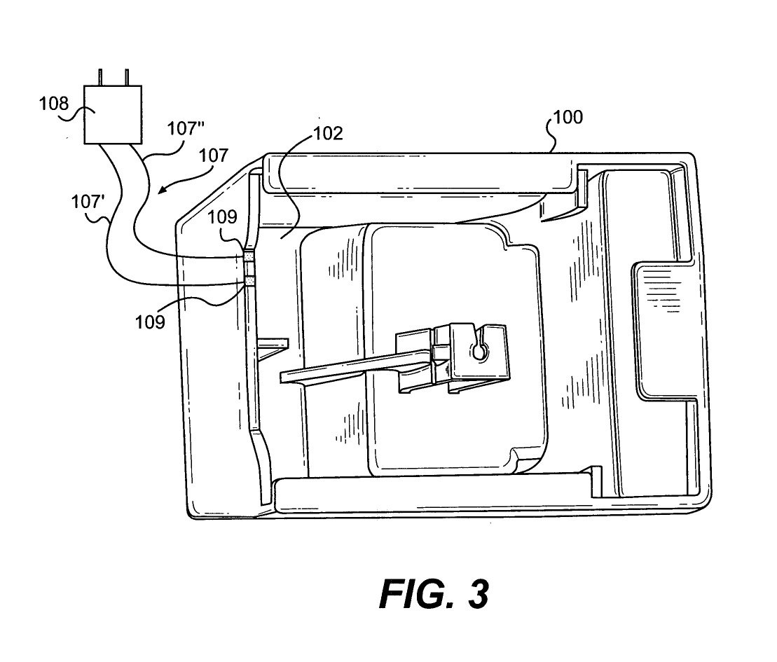

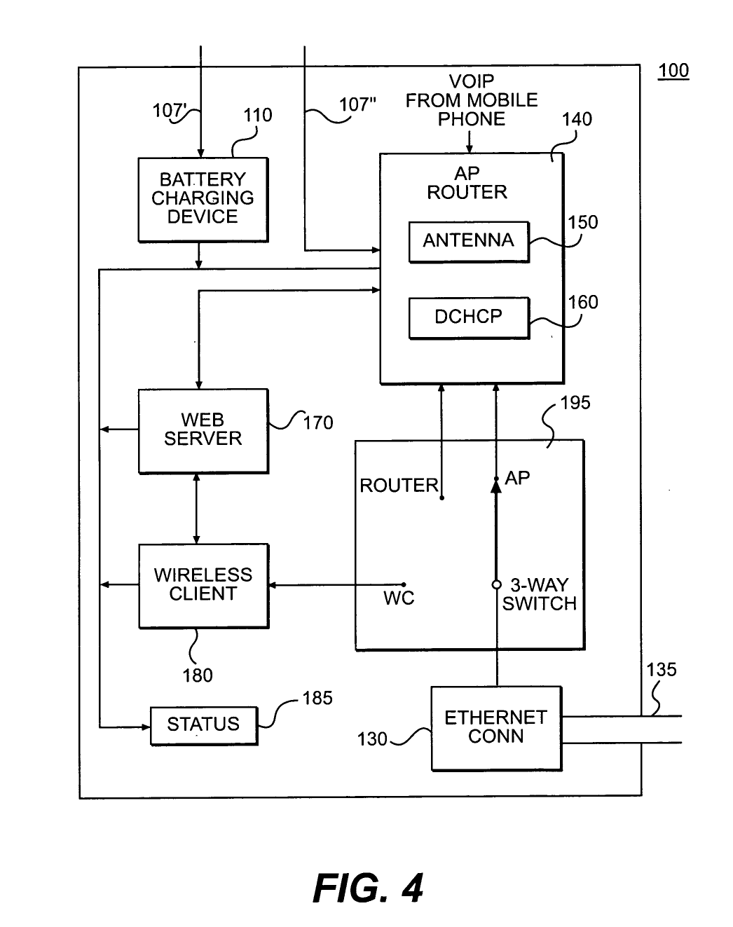

The second element 107″ of the combinational power cord 107 provides electrical power to other components of the combined mobile phone charging device and wireless server 100. These components will be described below with respect to FIG. 4. The combinational power cord 107 is detachable from the docking station 101 by connectors 109 (see FIG. 3).

An alternate embodiment of a combinational power cord for use with the base 100 is shown in FIG. 2B. Power cord 207 includes plug 208 that connects to a normal wall outlet to receive 120 V AC power. The power cord 207 terminates at stepdown module 209, which is incorporated into the base 100. The stepdown module 209 receives the input 120 V AC power and converts the input into DC power at the voltages and currents required for the components of the base 100. Power line 211 provides DC power to charge the battery of the mobile phone 200. Power line 213 provides DC power to other components of the base 100.

FIG. 3 is a bottom view of the base 100 showing hollow cavity 102 for receiving the battery charging device 110 and the other components of the base 100.

FIG. 4 is a block diagram of the combined mobile phone charging device and wireless server 100 showing individual hardware and software components. In particular, the combined mobile phone charging device and wireless server 100 includes the battery charging device 110, combinational power cord 107, Ethernet connection 130, AP (for Access Point) router 140 having internal antenna 150 and DHCP (for Dynamic Host Configuration Protocol) server 160, Web server 170, and wireless client module 180. The battery charging device 110 includes the electrical components and mechanical devices needed to couple the first element 107′ to the electrical contacts 106. The combinational power cord 107 has already been described in detail with reference to FIG. 2A. The remaining components are described below.

The base 100 may have its own Internet Protocol (IP) address, as determined by the DHCP server 160, and can be used to create a wireless network in a room where other wireless components, such as a wireless laptop computer, are located. Multiple wireless components can connect to the wireless network at the same time to share resources and files.

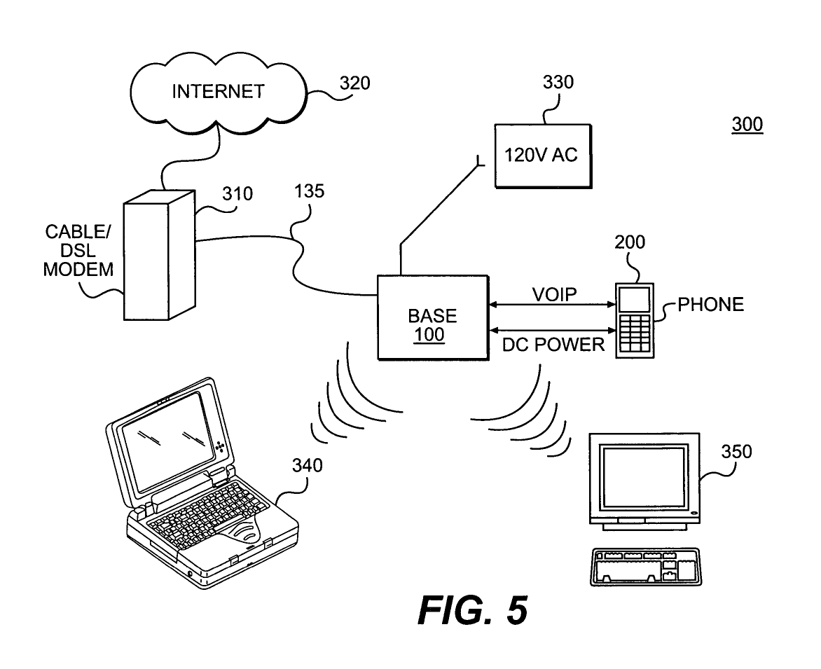

The AP router 140 is used to provide a single broadband source for wireless Internet connectivity. In a first mode of operation, cable 135 is used to connect the Ethernet connection 130 of the base 100 to a broadband DSL or cable modem (see FIG. 5). Alternatively, the AP router 140 is used to wirelessly couple the Internet to the base 100. Once the base 100 is connected to an appropriate source using the Ethernet connection 130, a local access point, or hot spot is created, to which a wireless device, such as a wireless-enabled laptop computer, can connect for Internet access.

The AP router 140 also receives a standard VoIP signal from the mobile phone 200 to establish VoIP communications with the Internet. Of course, the mobile phone 200 is capable of VoIP communications at other appropriate access points or hot spots. Because the AP router 140 and the phone 200 are used together with the base 100, no separate configuration or programming of the AP router 140 is needed for the phone 200 and the AP router 140 to communicate with each other. Finally, because the phone 200 is capable of VoIP, costly cellular phone charges can be avoided. The antenna 150 is used to transmit and receive signals. The antenna 150 is omni-directional and has zero gain. The antenna 150 is built or molded into the base 100.

The DHCP server 160 is nominally a component of the AP router 140. Dynamic Host Configuration Protocol is an Internet protocol for automating the configuration of computes that use TCP/IP. The DHCP server 160 automatically assigns IP addresses to ensure devices can connect to the Internet, delivers TCP/IP stack configuration parameters such as the subnet mask and default router, and provides other configuration information such as the addresses for print time and news servers. In addition, the DHCP server 160 supports virtual private network (VPN) pass-through and firewall features including Network Address Translation (NAT) and MAC filtering to protect the wireless network from outside attacks.

The Web server 170 is used to acquire content from the Internet. The Web server 170 then provides the content to various client devices that use the base 100 for wireless Web access.

The wireless client module 180 allows connection of, for example, a laptop computer, to an existing wireless network, without having to install drivers or additional software. Non-wireless-enabled devices can take advantage of the wireless functions of the base 100 when the non-wireless-enabled device is connected to the base 100 by appropriate means, such as by an Ethernet cable. The base 100 then serves as the wireless Internet access point for the non-wireless-enabled device.

The above-described base 100 is thus capable of operating in one of three modes, with the specific mode of operation controlled by operation of 3-way configuration switch 195. As noted above, the operating modes include an access point mode to create a wireless connection, a router mode to share an Internet connection, and a wireless client mode to connect an existing wireless network. In the access point mode, the base 100 can be used to create a wireless network, and multiple wireless clients can connect to the network at the same time to share resources and files.

In the router mode, the base 100 can be used to share a single broadband Internet connection, such as might be provided in a hotel room. The base 100 is connected to an external router (not shown) using the Ethernet connection 130. The AP router 140 then serves as a wireless access point, or hotspot, to which wireless-enabled devices can connect.

In the wireless client mode, the base 100 allows connection of, for example, a laptop computer, to an existing wireless network, without having to install drivers or additional software.

Although FIG. 4 shows the components of the base 100 as discrete items, the base 100 may accept a suitably-programmed communications card that provides the functions of AP server (including DHCP server), router, and wireless client. In this configuration of the base 100, the 3-way selector switch 195 is used to select an appropriate mode of operation of the base 100.

The base 100 is fully compatible with IEEE 802.11g devices and is backward compatible to 802.11b. The base 100 operates in the normal wireless frequency range of 2.412 GHz to 2.462 GHz.

The base 100 may incorporate display and status features 185 to provide an indication of their operational modes. For example, the base 100 may include a power-on LED to indicate connection to an AC power source, and a wireless LAN (WLAN) LED to indicate when the base 100 is operating in a wireless mode (i.e., supporting a local wireless network).

FIG. 5 is a conceptual diagram of the base 100 of FIG. 4 in an operating environment 300. As shown in FIG. 5, the base 100 receives standard line power from AC power source 330 and provides DC electrical power to charge the mobile phone 200. In addition, the base 100 connects the mobile phone 200 to the Internet to send and receive VoIP communications.

Also as shown in FIG. 5, the base 100 is configured so that the AP router 140 is operating in the AP mode. That is, the Ethernet cable 135 connects the base 100 to an appropriate cable or DSL modem 310, which in turn receives content from and otherwise serves as a communications connection with the Internet 320. Finally, the base 100 is in wireless communication with laptop computer 340 and PC 350.

We claim:

1. A mobile phone charging base, comprising:
a mobile phone charging device; and
a wireless communications module comprising:
an Internet Protocol (IP) access connection, and
a Voice over Internet Protocol connection.

2. The mobile phone charging base of claim 1, wherein the wireless communications module further comprises:
a wireless client module;
an access point (AP) router; and
a Web server.

3. The mobile phone charging base of claim 2, wherein the AP router comprises an omni-directional transmit/receive antenna.

4. The mobile phone charging base of claim 3, wherein the mobile phone charging base comprises a molded body, and wherein the antenna is built into the molded body.

5. The mobile phone charging base of claim 3, wherein the AP router further comprises a DHCP server.

6. The mobile phone charging base of claim 2, further comprising a combinational power supply cord, wherein the combination power cord comprises:
a power pack to convert a main line AC voltage power supply to low voltage DC power;
a first element to provide a first DC voltage to the mobile phone charging device; and
a second element to provide a second DC voltage to the AP router.

7. The mobile phone charging base of claim 2, further comprising:
an Ethernet port coupled to the AP router, wherein an external DSL or cable modem is connected to the charging base; and
a 3-way mode selector switch, wherein an operational mode of the wireless communications module is selectable from one of AP mode, router mode, and wireless client mode.

8. A combinational mobile phone charging device and wireless communications hub, comprising:
a mobile phone charging device;
an access point router, comprising:
a DHCP server, and
an omni-directional send/receive antenna;
a Web server; and
a wireless client module.

9. The combinational mobile phone charging device and wireless communications hub of claim 8, wherein access point server is compatible with a Voice over Internet Protocol (VoIP) mobile telephone, and further comprising a VoIP mobile phone.

10. The combinational mobile phone charging device and wireless communications hub of claim 8 further comprising a combinational power means that provides DC power to components of the combinational mobile phone charging device and wireless communications hub.

11. The combinational mobile phone charging device and wireless communications hub of claim 10, wherein the combinational power means comprises a power cord comprising:
a power pack that rectifies and steps down input voltage;
a first element that provides DC power to the mobile phone charging device; and
a second element that provides DC power to the AP router.

12. The combinational mobile phone charging device and wireless communications hub of claim 8, wherein the hub is capable of operating in one of three modes, and further comprising a 3-way selector switch for selecting a mode of operation.

13. The combinational mobile phone charging device and wireless communications hub of claim 8, further comprising an Ethernet connection, whereby the hub is connected to a laptop computer.

14. The combinational mobile phone charging device and wireless communications hub of claim 8, further comprising an Ethernet connection, whereby the hub is connected to the Internet.

15. A wireless communication hub for use with a mobile phone, comprising:
means for docking the mobile phone;
means for charging a battery of the mobile phone; and
means for establishing wireless Internet communications.

16. The wireless communications hub of claim 15, wherein the means for charging comprises a combinational power cord, comprising:
a first element that provides power to the charging means; and
a second element that provides power to the establishing means.

17. The wireless communications hub of claim 15, wherein the establishing means comprises:
an access point server, comprising:
a DHCP server,
an Ethernet connection, and
a send/receive antenna:
a Web server;
a wireless client module; and
means for selecting a mode of operation of the wireless communications hub.

18. The wireless communications hub of claim 15, wherein the establishing means comprises:
a communications card programmed to function as one of an access point server, a DHCP server, a Web server, and a wireless client module; and
a 3-way selector switch for selecting one of an AP mode, a Web server mode, and a wireless client mode.

19. The wireless communication hub of claim 15, wherein the mobile phone is a Voice over Internet Protocol (VoIP) phone, and wherein the access point server comprises means for connecting the VoIP phone to the Internet.

20. A method for providing wireless Internet communications, comprising:
providing a Voice over Internet Protocol (VoIP) mobile phone;
providing means to charge a battery of the VoIP mobile phone; and
providing a wireless communications hub, the wireless communications hub comprising:
an access point server,
a Web server, and
a wireless client module, wherein the charging means and the wireless communications hub are provided in a single housing.
